(19) United States
(12) Patent Application Publication
(10) Pub. No.: US 2024/0300074 A1
(43) Pub. Date: Sep. 12, 2024

(54) RATCHET WRENCH STRUCTURE

(71) Applicant: KABO TOOL COMPANY, Taichung City (TW)

(72) Inventor: Chih-Ching HSIEH, Taichung City (TW)

(21) Appl. No.: 18/597,442

(22) Filed: Mar. 6, 2024

(30) Foreign Application Priority Data
Mar. 7, 2023 (TW) 112108370

(51) Int. Cl. B25B 13/46; B25B 23/00; B25B 23/142

(52) U.S. Cl. CPC B25B 13/462; B25B 23/0028; B25B 23/1427

(57) ABSTRACT

A ratchet wrench structure includes a handle portion, a head portion, a ratchet hole, a ratchet portion, an extending rod and a driving portion. The head portion is connected to the handle portion. The ratchet hole penetrates the head portion and includes a plurality of first tooth portions, and the ratchet hole has a driving axis. The ratchet portion is detachably disposed at the ratchet hole, the ratchet portion includes a plurality of second tooth portions, and the second tooth portions correspond to the first tooth portions. A first end of the extending rod is integrally connected to the ratchet portion, and the extending rod extends along the driving axis. The driving portion is integrally connected to a second end of the extending rod and detachably connected to a workpiece.

### RELATED APPLICATIONS

This application claims priority to Taiwan Application Serial Number 112108370, filed Mar. 7, 2023, which is herein incorporated by reference.

### BACKGROUND

### Technical Field

The present disclosure relates to a wrench structure. More particularly, the present disclosure relates to a ratchet wrench structure.

### Description of Related Art

For assembling various tools, wrenches are applied in different industrial fields, and a ratchet wrench can rotate a workpiece in one direction, which may provide a convenience of operation. However, to meet the different requirements of products, a tool element such as a screw may be disposed in a narrow hole or other narrow working environments which are unfavorable for operating the ratchet wrench. For a conventional ratchet wrench, it is hard for a user to operate the conventional ratchet wrench in this kind of the working environments, or even impossible for the user to operate. Therefore, the practitioners in the filed developed a connecting element connected to the ratchet wrench to extend a driving head of the ratchet wrench so as to insert the driving head into the narrow working environments for operation. Nevertheless, a torque of the user rotating the ratchet wrench cannot be fully transmitted to the driving head because of a gap contained between the connecting element and the ratchet wrench, and the connecting element may be detached from the ratchet wrench due to the excessive torque, so that an operation of the ratchet wrench is limited.

Accordingly, a ratchet wrench which is capable of operating in a narrow working environment and fully transmitting a torque is still a pursued target of practitioners.

### SUMMARY

According to one aspect of the present disclosure, a ratchet wrench structure includes a handle portion, a head portion, a ratchet hole, a ratchet portion, an extending rod and a driving portion. The head portion is connected to the handle portion. The ratchet hole penetrates the head portion and includes a plurality of first tooth portions, and the ratchet hole has a driving axis. The ratchet portion is detachably disposed at the ratchet hole, the ratchet portion includes a plurality of second tooth portions, and the second tooth portions correspond to the first tooth portions. A first end of the extending rod is integrally connected to the ratchet portion, and the extending rod extends along the driving axis. The driving portion is integrally connected to a second end of the extending rod and detachably connected to a workpiece.

According to another aspect of the present disclosure, a ratchet wrench structure includes a handle portion, a head portion, a ratchet hole, a ratchet portion, an extending rod and a driving portion. The handle portion includes a pivot hole. The head portion is pivotally connected to the pivot hole. The ratchet hole penetrates the head portion and includes a plurality of first tooth portions, and the ratchet hole has a driving axis. When the head portion rotates about the pivot hole by a force, an angle is formed between the driving axis and a longitudinal direction of the handle portion. The ratchet portion is detachably disposed at the ratchet hole, the ratchet portion includes a plurality of second tooth portions, and the second tooth portions correspond to the first tooth portions. A first end of the extending rod is integrally connected to the ratchet portion, and the extending rod extends along the driving axis. The driving portion is integrally connected to a second end of the extending rod and detachably connected to a workpiece.

### BRIEF DESCRIPTION OF THE DRAWINGS

The present disclosure can be more fully understood by reading the following detailed description of the embodiment, with reference made to the accompanying drawings as follows:

FIG. 1 shows an exploded view of a ratchet wrench structure according to one embodiment of the present disclosure.

FIG. 2 shows a schematic view of the ratchet wrench structure according to the embodiment in FIG. 1 connected to a workpiece which is disposed in a working groove.

FIG. 3 shows an exploded view of a ratchet wrench structure according to another embodiment of the present disclosure.

### DETAILED DESCRIPTION

The embodiments will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as being “connected to” another element, it can be directly connected to the other element, or it can be indirectly connected to the other element, that is, intervening elements may be present. In contrast, when an element is referred to as being “directly connected to” another element, there are no intervening elements present. In addition, the terms first, second, third, etc. are used herein to describe various elements or components, these elements or components should not be limited by these terms. Consequently, a first element or component discussed below could be termed a second element or component. Besides, a combination of these elements (unite or circuits) of the present disclosure is not a common combination in this art, so it cannot be predicted whether a relation of the combination hereof can be easily done by a person having skill in the art by these elements (units or circuits).

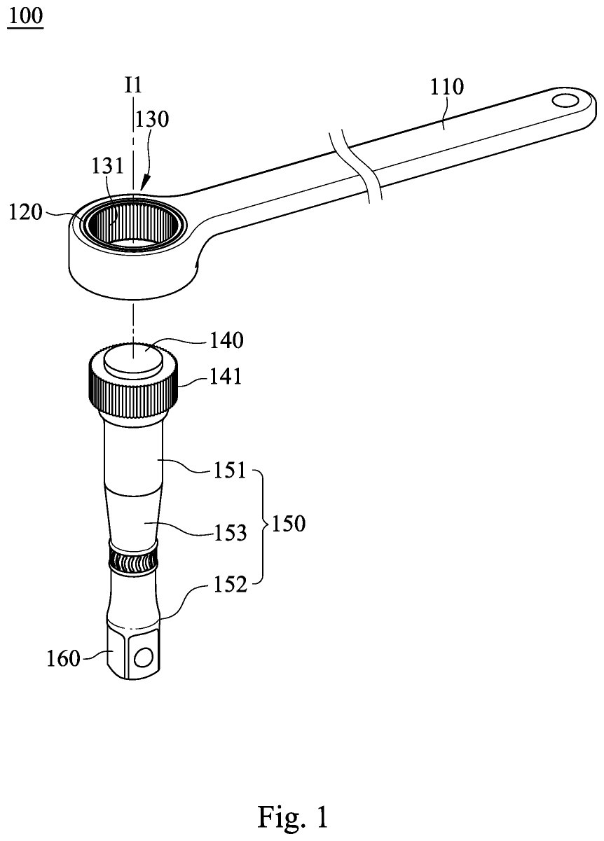

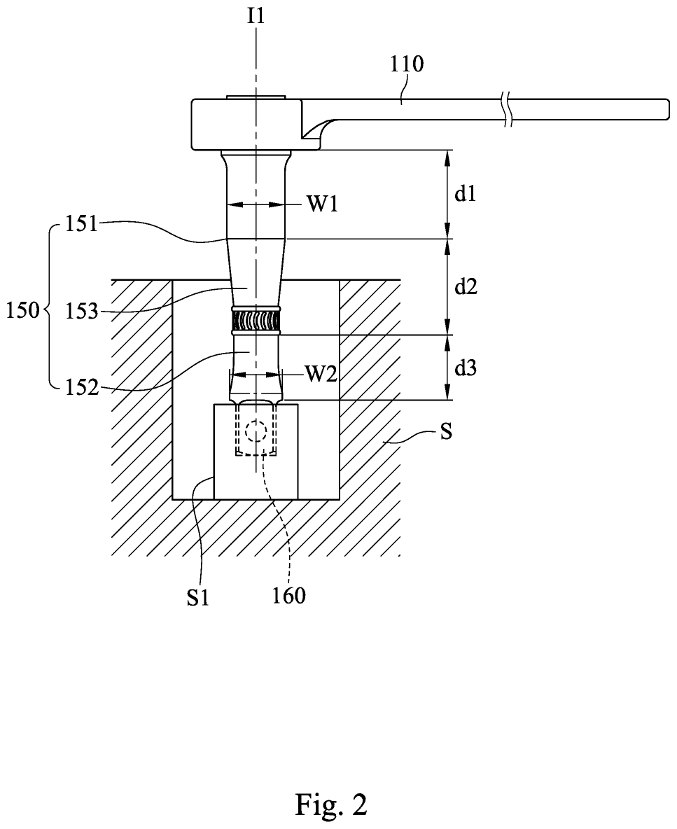

Please refer to FIG. 1, and FIG. 1 shows an exploded view of a ratchet wrench structure 100 according to one embodiment of the present disclosure. As shown in FIG. 1, the ratchet wrench structure 100 includes a handle portion 110, a head portion 120, a ratchet hole 130, a ratchet portion 140, an extending rod 150 and a driving portion 160. The head portion 120 is connected to the handle portion 110, the ratchet hole 130 penetrates the head portion 120 and includes a plurality of first tooth portions 131, and the ratchet hole 130 has a driving axis I1. The ratchet portion 140 is detachably disposed at the ratchet hole 130, the ratchet portion 140 includes a plurality of second tooth portions 141, and the second tooth portions 141 correspond to the first tooth portions 131. A first end of the extending rod 150 is integrally connected to the ratchet portion 140, and the extending rod 150 extends along the driving axis I1. The driving portion 160 is integrally connected to a second end of the extending rod 150 and detachably connected to a workpiece S1 (shown in FIG. 2).

Therefore, a user can handle the handle portion 110 and insert the driving portion 160 into a narrow working environment where a conventional ratchet wrench is incapable of operating (as a working groove S shown in FIG. 2), and a rotated torque driven by the user can be fully transmitted to the driving portion 160 via a long-rod structure integrally formed by the ratchet portion 140, the extending rod 150 and a driving portion 160. That is, a problem that a torque cannot be fully transmitted to a driving portion because of the connection between a ratchet portion and an extending rod of the conventional ratchet wrench can be avoided so as to increase a torque output of the driving portion 160. The detailed structure of the ratchet wrench structure 100 will be described in the following.

Please refer to FIG. 2 with FIG. 1, and FIG. 2 shows a schematic view of the ratchet wrench structure 100 according to the embodiment in FIG. 1 connected to the workpiece S1 which is disposed in the working groove S. As shown in FIGS. 1 and 2, the handle portion 110 and the head portion 120 can form an integrally formed wrench, and a reversing mechanism can be disposed at the head portion 120 so as to allow the ratchet portion 140 to be rotated in one direction or dual directions. The reversing mechanism is conventional and is not an improving feature of the present disclosure, so it won't be described herein. In other embodiments, the head portion can be detachably connected to the handle portion, and the ratchet wrench structure can further include a torque trip mechanism connected to the head portion so as to set an upper limit of a torque output to prevent the extending rod from being broken by an excessive torque.

The extending rod 150 can include a first extending region 151, a tapering region 153 and a second extending region 152. The first extending region 151 is integrally connected to the ratchet portion 140 and has a first radial width W1. The tapering region 153 is integrally connected to the first extending region 151, and a radial width of the tapering region 153 is tapered from an end of the tapering region 153 connected to the first extending region 151 towards the driving portion 160. The second extending region 152 is integrally connected between the tapering region 153 and the driving portion 160 and has a second maximum radial width W2, and the first radial width W1 is larger than the second maximum radial width W2. It is worthy to be mentioned that there is no real boundary between the first extending region 151 and the tapering region 153, or between the tapering region 153 and the second extending region 152, dividing the extending rod 150 into the first extending region 151, the tapering region 153 and the second extending region 152 is only for descriptive convenience, and the present disclosure is not limited thereto. The radial width of the extending rod 150 is tapered from the first radial width W1 of the first extending region 151 to the other end of the tapering region 153 connected to the second extending region 152, and then is gradually increased to the second maximum radial width W2 in the second extending region 152. The radial width of the extending rod 150 changes smoothly to avoid of an excessive stress occurred at a point where the radial width of the extending rod 150 changes when the user rotates the ratchet wrench structure 100 so that the loading of the extending rod 150 can be improved. In other embodiments, the extending rod can exclude the tapering portion and radial widths of regions of the extending rod are equal, that is, the extending rod is a straight rod so as to reduce a manufacturing difficulty.

The first radial width W1 can be larger than or equal to 15 mm and less than or equal to 20 mm, the second maximum radial width W2 can be larger than or equal to 14 mm and less than or equal to 19 mm. In the present embodiment, the first radial width W1 is 17.5 mm, the second maximum radial width W2 is 16.5 mm, but the present disclosure is not limited thereto. Via a design that the first radial width W1 is larger than the second maximum radial width W2, the user can insert the driving portion 160 into a narrow work space such as the working groove S of a working element shown in FIG. 2, and then connect the driving portion 160 to the workpiece S1 to drive the workpiece S1. In other embodiments, the second maximum radial width of the second extending region can be larger than the first radial width of the first extending region so as to drive a workpiece with large radius, but the present disclosure is not limited thereto.

A length d1 of the first extending region 151 can be larger than or equal to 25 mm and less than or equal to 35 mm, a length d2 of the tapering region 153 can be larger than or equal to 25 mm and less than or equal to 35 mm, and a length d3 of the second extending region 152 can be larger than or equal to 15 mm and less than or equal to 25 mm. The length d1 of the first extending region 151, the length d2 of the tapering region 153 and the length d3 of the second extending region 152 are 30 mm, 30 mm and 20 mm, respectively, but the present disclosure is not limited thereto. Therefore, the extending rod 150 can be inserted into a hole of a working environment and applied for most of working environments of the ratchet wrench structure 100 to improve the convenience of operating the ratchet wrench structure 100 in a narrow space.

Moreover, the extending rod 150 can be substantially cylinder-shaped. A cylinder-shaped structure can avoid that a stress is focused at a specific point of the extending rod 150 so as to transmit the torque driven by the user to each point of the extending rod 150 averagely. Thus, the stress on the extending rod 150 does not change rapidly to prevent the extending rod 150 from being broken owing to an excessive stress at a certain region of the extending rod 150, so that the lifetime of the extending rod 150 can be increased. In other embodiments, the extending rod can be cuboid-shaped or other polygon prism-shaped, but the present disclosure is not limited thereto.

In other embodiments, the ratchet wrench structure can further include a torque sensor, and the torque sensor is disposed at the driving portion and is configured for sensing a torque value of the driving portion acting on the workpiece. Compared with a conventional torque sensor disposed at the handle portion of the ratchet wrench, via disposing the torque sensor at the driving portion, the torque value of the driving portion acting on the workpiece can be sensed more accurately, and the accuracy of the torque sensor can be improved.

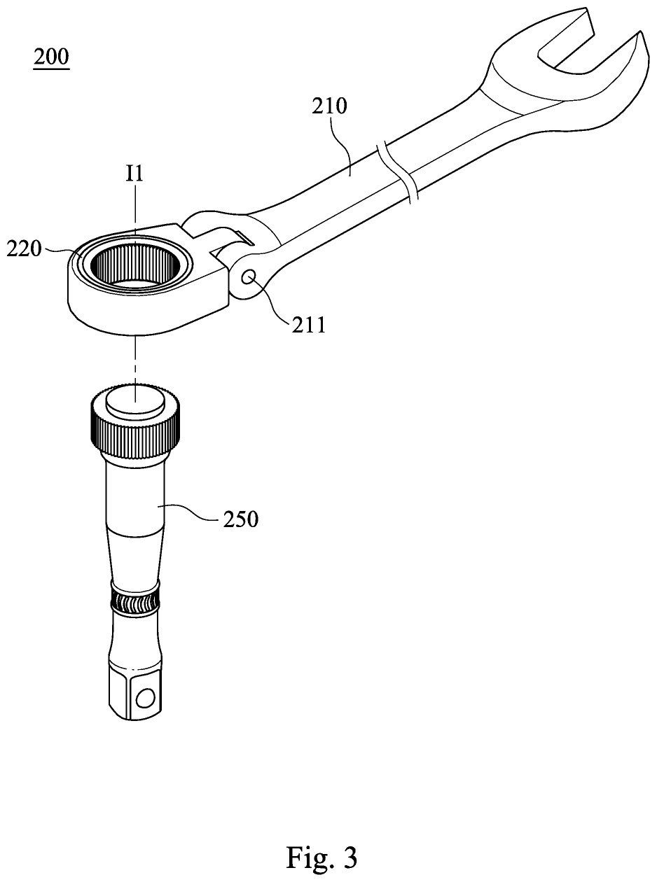

Please refer to FIG. 3, and FIG. 3 shows an exploded view of a ratchet wrench structure 200 according to another embodiment of the present disclosure. As shown in FIG. 3, a structure of the ratchet wrench structure 200 is similar with the ratchet wrench structure 100 of the embodiment in FIG. 1. It is worthy to be mentioned that a handle portion 210 of the ratchet wrench structure 200 can include a pivot hole 211, and a head portion 220 is pivotally connected to the pivot hole 211. When the head portion 220 rotates about the pivot hole 211 by a force, an angle is formed between a driving axis I1 and a longitudinal direction of the handle portion 210. In detail, the ratchet wrench structure 200 is a swing-type ratchet wrench. Via the configuration of the pivot hole 211, a user can rotate the head portion 220 to deflect the head portion 220 relatively to the handle portion 210 so as to incline an extending rod 250 relatively to the longitudinal direction of the handle portion 210, which is convenient for the user to adjust an angle between the driving axis I1 and the handle portion 210 and then insert the extending rod 250 into a narrow and convoluted working environment, thereby improving the convenience of operating the ratchet wrench structure 200.

In summary, the ratchet wrench structure of the present disclosure has the following advantages. First, via the configuration of integrally forming the ratchet portion, the extending rod and the driving portion, the torque value of the driving portion acting on the workpiece can be increased. Second, via the configuration of the deflectable handle portion, the angle between the driving axis and the handle portion can be adjusted to improve the convenience of operating the ratchet wrench structure. And, third, via disposing the torque sensor at the driving portion, the torque value of the driving portion acting on the workpiece can be sensed more accurately.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A ratchet wrench structure, comprising:
a handle portion;
a head portion connected to the handle portion;
a ratchet hole penetrating the head portion and comprising a plurality of first tooth portions, and the ratchet hole having a driving axis;
a ratchet portion detachably disposed at the ratchet hole, the ratchet portion comprising a plurality of second tooth portions, and the second tooth portions corresponding to the first tooth portions;
an extending rod, wherein a first end of the extending rod is integrally connected to the ratchet portion, and the extending rod extends along the driving axis; and
a driving portion integrally connected to a second end of the extending rod and detachably connected to a workpiece.

2. The ratchet wrench structure of claim 1, wherein the extending rod comprises:
a first extending region integrally connected to the ratchet portion and having a first radial width;
a tapering region integrally connected to the first extending region, wherein a radial width of the tapering region is tapered from an end of the tapering region connected to the first extending region towards the driving portion; and
a second extending region integrally connected between the tapering region and the driving portion and having a second maximum radial width, wherein the first radial width is larger than the second maximum radial width.

3. The ratchet wrench structure of claim 2, wherein the first radial width is larger than or equal to 15 mm and less than or equal to 20 mm, and the second maximum radial width is larger than or equal to 14 mm and less than or equal to 19 mm.

4. The ratchet wrench structure of claim 2, wherein a length of the first extending region is larger than or equal to 25 mm and less than or equal to 35 mm, a length of the tapering region is larger than or equal to 25 mm and less than or equal to 35 mm, and a length of the second extending region is larger than or equal to 15 mm and less than or equal to 25 mm.

5. The ratchet wrench structure of claim 1, wherein the extending rod comprises:
a first extending region integrally connected to the ratchet portion and having a first radial width; and
a second extending region integrally connected to the first extending region and having a second maximum radial width, wherein the second maximum radial width is larger than the first radial width.

6. The ratchet wrench structure of claim 1, further comprising a torque sensor, wherein the torque sensor is disposed at the driving portion and is configured for sensing a torque value of the driving portion acting on the workpiece.

7. A ratchet wrench structure, comprising:
a handle portion comprising a pivot hole;
a head portion pivotally connected to the pivot hole;
a ratchet hole penetrating the head portion and comprising a plurality of first tooth portions, and the ratchet hole having a driving axis, wherein when the head portion rotates about the pivot hole by a force, an angle is formed between the driving axis and a longitudinal direction of the handle portion;
a ratchet portion detachably disposed at the ratchet hole, the ratchet portion comprising a plurality of second tooth portions, and the second tooth portions corresponding to the first tooth portions;
an extending rod, wherein a first end of the extending rod is integrally connected to the ratchet portion, and the extending rod extends along the driving axis; and
a driving portion integrally connected to a second end of the extending rod and detachably connected to a workpiece.

8. The ratchet wrench structure of claim 7, wherein the extending rod comprises:
a first extending region integrally connected to the ratchet portion and having a first radial width;
a tapering region integrally connected to the first extending region, wherein a radial width of the tapering region is tapered from an end of the tapering region connected to the first extending region towards the driving portion; and
a second extending region integrally connected between the tapering region and the driving portion and having a second maximum radial width, wherein the first radial width is larger than the second maximum radial width.

9. The ratchet wrench structure of claim 8, wherein the first radial width is larger than or equal to 15 mm and less than or equal to 20 mm, and the second maximum radial width is larger than or equal to 14 mm and less than or equal to 19 mm.

10. The ratchet wrench structure of claim 8, wherein a length of the first extending region is larger than or equal to 25 mm and less than or equal to 35 mm, a length of the tapering region is larger than or equal to 25 mm and less than or equal to 35 mm, and a length of the second extending region is larger than or equal to 15 mm and less than or equal to 25 mm.

11. The ratchet wrench structure of claim 7, wherein the extending rod comprises:
a first extending region integrally connected to the ratchet portion and having a first radial width; and
a second extending region integrally connected to the first extending region and having a second maximum radial width, wherein the second maximum radial width is larger than the first radial width.

12. The ratchet wrench structure of claim 7, further comprising a torque sensor, wherein the torque sensor is disposed at the driving portion and is configured for sensing a torque value of the driving portion acting on the workpiece.
